(19) United States
(12) Patent Application Publication
(10) Pub. No.: US 2020/0058996 A1
(43) Pub. Date: Feb. 20, 2020

(54) PASSIVE BEAMFORMING ANTENNA SYSTEM

(71) Applicant: NOKIA SOLUTIONS AND NETWORKS OY, Espoo (FI)

(72) Inventor: Ajit REDDY, Cliffwood, NJ (US)

(21) Appl. No.: 16/386,949

(22) Filed: Apr. 17, 2019

(30) Foreign Application Priority Data
Aug. 16, 2018 (FI) 20185685

(51) Int. Cl. H01Q 3/26; H01Q 1/24; H04B 7/08; H01Q 3/36

(52) U.S. Cl. CPC H01Q 3/267; H01Q 3/36; H04B 7/0874; H01Q 1/246

(57) ABSTRACT

A beamforming antenna system comprises an antenna array comprising a plurality of antenna elements and a plurality of reconfigurable passive network blocks connected to the antenna array and configured to form beams for transmission and reception according to a configuration of each reconfigurable passive network block. The beamforming antenna system comprises a plurality of radio frequency front ends connected to a plurality of analog front ends configured to convert radio frequency signals to digital baseband signals and vice versa and a baseband processing apparatus configured to generate a digital baseband signal to be fed via a divider circuit to the plurality of analog front ends for transmission, to process a baseband signal received via a combiner circuit from the plurality of analog front ends and to control the configuration of the plurality of reconfigurable passive network blocks.

### FIELD OF THE INVENTION

Various example embodiments relate generally to wireless communications, and more particularly to beamforming antenna systems.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

The fifth generation (5G) cellular systems aim to improve the throughput by a huge factor (even up to 1000 or more), which presents a multitude of challenges, especially considering the scarcity of spectrum at low frequency bands and the need for supporting a very diverse set of use cases. In order to reach this goal, it is important to exploit the higher frequencies such as millimeter wave frequencies in addition to the more conventional lower frequencies. Millimeter-wave antennas employed in 5G user equipment need not only be small but also to provide reduced power consumption to maximize the battery life of the user equipment. There is also need for relatively fast scanning for the beam detection in these antennas for them to work reliably over given distances and profiles at millimeter wave frequencies. The present beamforming systems using active devices consume a lot of power thus imposing a drain on the batteries and also causing these devices to heat up. They also need to be calibrated due to the inaccuracies of the active devices with varying temperatures. Thus, there is a need for a new type of beamforming solution for use specifically in 5G user equipment.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, apparatuses, and computer programs as defined in the independent claims. Further embodiments of the invention are disclosed in the dependent claims.

### BRIEF DESCRIPTION OF THE DRAWINGS

In the following, some example embodiments will be described with reference to the accompanying drawings, in which

FIG. 1 illustrates an example of a communications system to which embodiments may be applied;

FIG. 2 illustrates an exemplary beamforming architecture according to embodiments;

FIG. 3 illustrates a passive network block according to embodiments;

FIG. 4 illustrates a switch arrangement according to embodiments;

FIG. 5 illustrates a passive network matrix element according to embodiments;

FIGS. 6 and 7 illustrate exemplary processes for beam scanning and detection according to embodiments; and

FIG. 8 illustrates an exemplary baseband processing apparatus according to embodiments.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

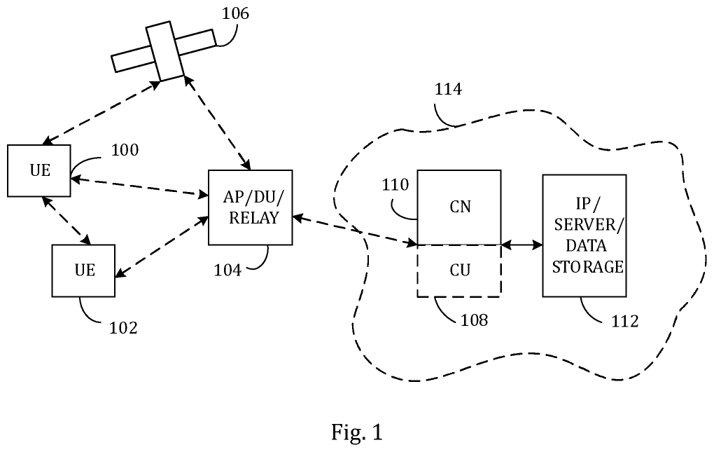

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point, an access node or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. The systems and processes described in relation to the embodiments discussed below may be implemented in a user device as described here.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT (information and communications technology) devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave (centimeter wave) and mmWave (millimeter wave), and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablet computers and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication system may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

One key element necessary in overcoming high path and penetration losses of millimeter wavelengths and thus achieving high throughput broadband communications envisioned for 5G communication systems like the one shown in FIG. 1 is the use of beamforming techniques. Beamforming techniques employ an array antenna comprising a plurality of antenna elements, for example, in a rectangular or square configuration. By tuning the phase and/or amplitude of the signals fed to each antenna element, different antenna patterns may be produced due to the electromagnetic waves produced by the individual antenna elements interfering with each other constructively and destructively in different directions. In particular, the radiation pattern of the antenna array may be tuned so that a narrow main beam of the radiation pattern may be directed to different directions (e.g., different directions defined through azimuth and/or elevation angles). In other words, the electromagnetic waves may be focused in a desired direction. In addition to the direction of the main lobe, the sidelobe levels and the nulls of the pattern may also be controlled. The beamforming works in a reciprocal manner, that is, it may be employed equally in transmission and reception.

In conventional (or fixed) beamforming, a fixed set of complex weighting factors (i.e., amplitude and phase conversions) are applied to the signals fed to the antenna elements based on the information on the direction of interest to focus the beam to said direction of interest. In adaptive beamforming, this information is combined with properties of the signals received by the array. However, in some scenarios the position of the transceiver transmitting a signal and to which signals are to be transmitted is unknown. In such cases before a beam may be formed and the transmitted signal may be received, it may, first, be detected that a signal which may be received exists and, second, from which direction the transmitted signal is transmitted. Multiple different spectrumsensing solutions have been proposed for achieving this.

Beamforming techniques may be divided to active and passive (switched-beam) techniques. The beam produced by the active techniques may be steered and shaped simply by changing the power level and phases being output by radio transmitters to the antenna elements. For example, each antenna element or each column of antenna elements (assuming a rectangular array) may be fed by a dedicated radio transmitter. The beam can be steered to any angle within the specified range of the system and its sidelobes suppressed as needed. While active solutions provide very effective and robust steering, they also come with several considerable disadvantages. Obviously, the reliance on active devices leads to considerable power consumption and possibly also heating of the device itself, both of which are especially problematic properties in the context of battery-powered user equipment. While the problem of heating may be overcome by adding a heat sink, such a solution is not possible with many battery-powered user equipment where the size and weight of the device cannot be compromised. The beamforming antenna systems also need to be calibrated due to the inaccuracies of the active devices with changing temperatures. Beamforming systems at millimeter wave frequencies have concentrated almost exclusively on active beamforming techniques.

As stated in the previous paragraphs, passive beamforming techniques are preferable for some applications such as for battery-powered user equipment due to the reduced power consumption and heating. Further, passive beamforming techniques have also the benefits of being reciprocal (i.e., the same performance in transmission and reception) and linear (i.e., the performance is not affected by signal power levels) and enabling faster switching (i.e., faster adjustment of the beam direction) compared to the active techniques. In conventional passive beamforming techniques, the phases and amplitudes of the signals fed to (or received from) the individual antenna elements are controlled by a passive power divider (or combiner). This design leads to the number of beams, their pointing angles and sidelobe levels being a discrete number. In other words, the beam cannot be adjusted as freely as with active beamforming techniques though by designing the passive beamforming system smartly (as will be discussed in relation to embodiments) a large number of beams may be realized so as to meet the needs of most applications.

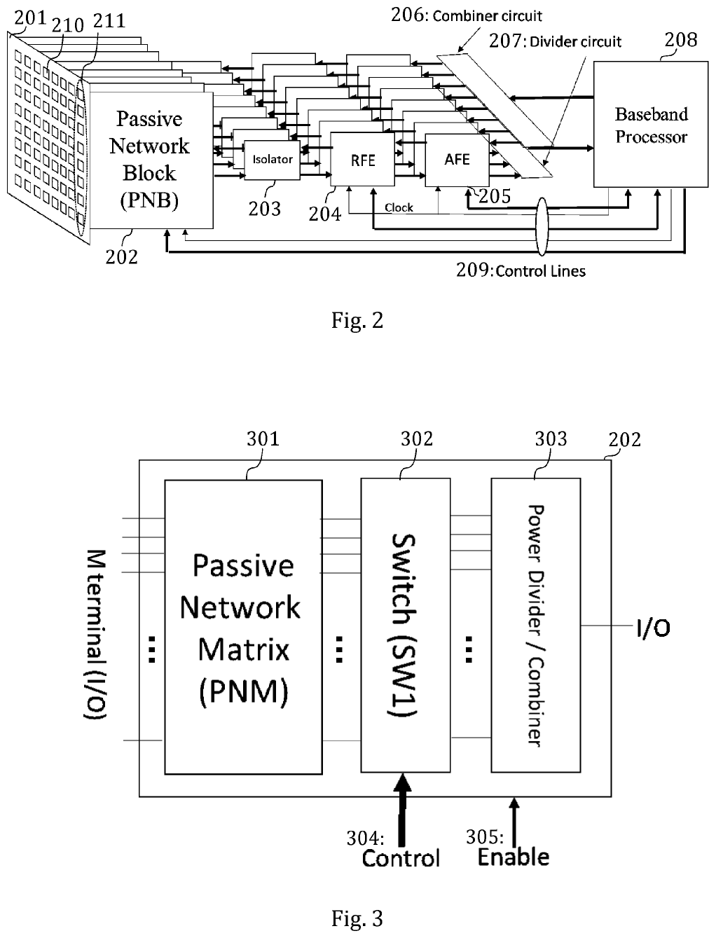

FIG. 2 illustrates a beamforming (antenna) system according to an embodiment for overcoming at least some of the problems described above. The illustrated beamforming antenna system may be configured to perform passive beamforming as well as beam scanning and beam detection. The beamforming antenna system according to embodiments comprises at least an antenna array 201, a plurality of reconfigurable passive network blocks 202, a plurality of radio frequency, RF, front ends 204, a plurality of analog front ends 205 and a baseband processing apparatus 208. In the following discussion, vertical direction is defined as an upward direction in FIG. 2 and horizontal direction as a direction parallel to the plane of the antenna array and orthogonal to the vertical direction.

Referring to FIG. 2, the beamforming antenna system comprises an antenna array 201 (specifically, a two-dimensional antenna array) comprising a plurality of antenna elements 210 for transmitting and receiving electromagnetic waves (or specifically radio signals and/or millimeter wave frequency signals). While in FIG. 2 a square antenna array 201 consisting of 8×8 periodically arranged square microstrip antenna elements 210 is depicted, it should be appreciated that embodiments are not limited to this particular antenna array. In other embodiments, the shape of the antenna array may be, for example, rectangular (i.e., N×M array where N, M are integers larger or equal to one or two to allow for beam scanning in both azimuth and elevation), polygonal, spherical or elliptical and/or the antenna elements may not be arranged along a Cartesian grid but along a more general regular grid or even curvilinear grid. Further, the individual microstrip antenna elements may have almost any shape, for example, rectangular, polygonal, spherical or elliptical shape. In some embodiments, the antenna elements may not even be microstrip antenna elements but, for example, dipole antenna elements.

Assuming a rectangular antenna array 201 with N×M antenna elements 210 (e.g., 8×8 antenna elements as in FIG. 2), each set of M antenna elements 211 (equal to N antenna elements in FIG. 2 as N=M=8) oriented along a vertical line may be connected or coupled to a passive network block (PNB) 202. Specifically, each passive network block 202 has M ports each of which is connected to a different antenna element and each antenna element is connected only to a single passive network block. Thus, the beamforming antenna system of FIG. 2 comprises altogether N passive network blocks. In other words, the beamforming antenna system may be considered to comprise a set of N linear phased arrays 211 comprising M antenna elements 210 and oriented along the vertical direction with the phases of each individual antenna element in a phased array 211 being controllable by the corresponding passive network block 202. Each passive network block 202 also has a port for receiving a signal to be transmitted from an isolator 203 and a port for transmitting a received signal to an isolator 203.

Each passive network block 202 is a reconfigurable passive network element which is configured to form beams for transmission and reception by modifying signals to be fed to and received from the plurality of antenna elements 210 (that is, phase and/or amplitude of said signals) according to a configuration of each reconfigurable passive network block. The configuration may be defined based on a state of a switch arrangement comprised in each reconfigurable passive network block. Specifically, by changing the configuration of a given reconfigurable passive network block 202 the beam created by the corresponding M antenna elements 211 may be adjusted in terms of the elevational properties of the beam (i.e., elevational beamwidth and elevational pointing angle). Elevation (angle) is defined here as an angle relative to a reference plane defined to be orthogonal to the plane of the antenna array 201 and piercing the center of the antenna array 201. Each reconfigurable passive network block 202 may be connected to two or more antenna elements.

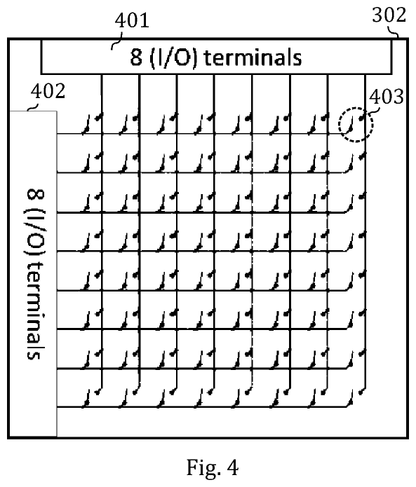

Each passive network element may comprise, for example, a passive network matrix element (comprising, e.g., one or more of couplers, phase shifters, power dividers and/or power combiners), a switch arrangement and power combiner—power divider element. At least some of the switches in the switch arrangement may be controllable using the baseband processing apparatus 208. The passive network block according to an embodiment is discussed in detail in relation to FIG. 3.

As mentioned above, the plurality of passive network block 202 may be connected to a plurality of isolators 203. Each isolator may, in turn, be connected to a radio frequency, RF, front end 204. The isolator allows transmission of electromagnetic waves (i.e., radio waves or millimeter waves) only in one direction in each path of the isolator, namely towards the antenna array 201 in a transmission path of the isolator or away from the antenna array 201 in a reception path of the isolator. Each isolator 203 may comprise two two-port isolators: one for the transmission path and another for the receiving path. In some embodiments, the isolator 203 may not be a separate element but be integrated into the corresponding RF front end 204 or passive network block 202. Each isolator 203 may be an ultra-wideband isolator. In some embodiments, each (ultra-wideband) isolator may be a switch connecting the transmit and receive paths.

In some embodiments, some or all of the plurality of isolators 203 may be RF switches (assuming time division duplexing, TDD, mode).

The plurality of RF front ends 204 are configured to convert radio frequency signals received from the plurality of reconfigurable passive network blocks 202 (via the plurality of isolators 203) to baseband signals in transmit paths of the plurality of RF front ends 204 and to convert baseband signals from the plurality of analog front ends 205 to radio frequency signals for transmission via the plurality of reconfigurable passive network blocks (and the plurality of isolators 203) in receive paths of the plurality of RF front ends 204. Each RF front end 204 may comprise in a transmit path of the RF front end 204 one or more power amplifiers, one or more upconverters (i.e., upconverting RF mixers) and/or one or more RF filters and in a receive path of the RF front end 204 one or more RF filters, one or more downconverters (i.e., downconverting RF mixers) and one or more (low noise) amplifiers. The RF filters may, specifically, comprise one or more band-pass filters for reducing the image response of the RF mixers. Each RF front end may further comprise a local oscillator for providing a local oscillator signal for the up- and/or downconverters. The baseband processing apparatus 208 may be configured to control gain (i.e., gain of at least one power or low noise amplifier) and/or clock of each RF front end 204. The gain may be controlled, for example, by controlling a control voltage of one or more power or low noise amplifiers while the clock may be controlled by simply providing a clock signal.

The plurality of analog front ends 205 are configured to convert the baseband signals received via the plurality of RF front ends 204 to digital baseband signals in transmit paths of the plurality of analog front ends 205 and to convert digital baseband signals to radio frequency signals for transmission via the plurality of RF front ends in receive paths of the plurality of analog front ends 205. Each analog front end 205 may comprise, for example, in a transmit path of the analog front end 205 one or more digital-to-analog converters and/or one or more filters and in a receive path of the analog front end 205 one or more of filters, one or more gain amplifiers and/or one or more analog-to-digital converters. The baseband processing apparatus 208 may be configured to control gain (i.e., gain of at least one amplifier) and/or clock of each analog front end 205. The gain may be controlled, for example, by controlling a control voltage of one or more gain amplifiers while the clock may be controlled by simply providing a clock signal which may be the same clock signal which is provided to the plurality of RF front ends 204.

The baseband processing apparatus 208 (e.g, a baseband processor) is configured to generate a digital baseband signal to be fed via a divider circuit 207 to the plurality of analog front ends 205 for transmission and to process a baseband signal received via a combiner circuit 206 from the plurality of analog front ends 205. In other words, the baseband processing apparatus 208 is connected to the transmit paths of the plurality of analog front ends 205 via the divider circuit 207 while the receive paths of the plurality of analog front ends 205 are connected via the combiner circuit 206 to the baseband processing apparatus 208. The baseband processing apparatus 208 may feed a single digital baseband signal to the divider circuit 207 wherein the stream is de-multiplexed into multiple digital baseband signals which are fed to the respective paths of the plurality of analog front ends 205. Similarly, in reception the combiner circuit combines (multiplexes) the multiple digital baseband signals received from the plurality of analog front ends 205 into a single digital baseband signal which is fed to the baseband processing apparatus 208. The processing of the baseband signal by the baseband processing apparatus 208 may comprise at least decoding or demodulating the baseband signal to acquire the original digital stream which was transmitted. Further, the processing of the baseband signal by the baseband processing apparatus 208 may entail performing matched filtering and/or synchronization on the decoded signal by correlating a known signal pattern with the filtered signal, wherein the known signal pattern corresponds to one of a preamble, midamble, a regularly transmitted pilot pattern and a spreading sequence.

Moreover, the baseband processing apparatus 208 may be configured to control the plurality of reconfigurable passive network blocks 202 (i.e., at least switching of the switch arrangements therein), the plurality of RF front ends 204 and the plurality of analog front ends 205, as described above. In some embodiments, the baseband processing apparatus may not control all of said devices. Instead, the baseband processing apparatus may control only one or more reconfigurable passive network blocks 202, one or more RF front ends 204 and/or one or more analog front ends 205.

While the control of the plurality of reconfigurable passive network blocks 202 enables the control of beam scanning in an elevation direction by the baseband processing apparatus, the baseband process apparatus 208 may be configured to control beam scanning also in an azimuth direction by controlling phase shifting applied by the divider circuit 207 to signals fed to the plurality of analog front ends 205 in transmission and by the combiner circuit 206 to signals received from the plurality of analog front ends 205 in reception (i.e., controlling the multiplexing and the de-multiplexing). By applying different phase shifts to signals transmitted to or received from different analog front ends (which are connected to adjacent linear phased arrays 211), transmission/reception beams with different azimuth pointing directions may be realized enabling the beam scanning operation in azimuth.

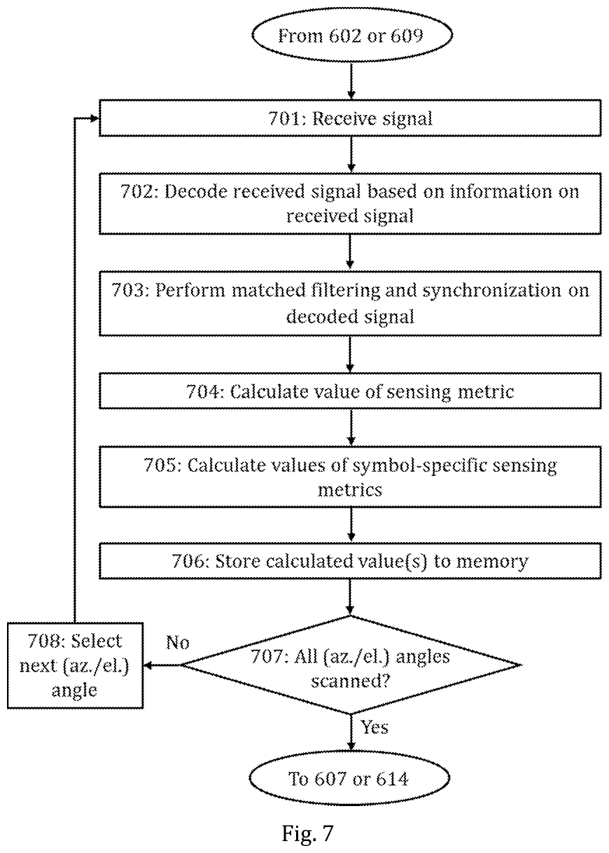

The baseband processing apparatus and its operation are further discussed in relation to FIGS. 6 to 8.

In some embodiments, one or more of the plurality of RF front ends, the plurality of analog front ends, the combiner circuit, the divider circuit and the baseband processing apparatus may be implemented (as a planar structure) on a single chip. In an embodiment, all of the plurality of RF front ends, the plurality of analog front ends, the combiner circuit, the divider circuit and the baseband processing apparatus are implemented on the single chip. The antenna array and the plurality of passive network blocks may be comprised in an antenna module. Further, the chip may be integrated into said antenna module. In some embodiments, the beamforming antenna system (or specifically the antenna array 201, the plurality of isolators 203, the plurality of RF front ends 204 and the plurality of analog front ends 205) may be configured to operate at a bandwidth comprised fully or in part in the millimeter wave frequency band (30 GHz to 300 GHz).

FIG. 3 illustrates an exemplary embodiment for implementing a reconfigurable passive network block 202 as discussed in relation to FIG. 2. Each of the plurality of reconfigurable passive network blocks may have the same basic composition as illustrated in FIG. 3 though the individual elements and their configuration (i.e., state of the switch arrangement) may differ.

Referring to FIG. 3, the reconfigurable passive network blocks comprises a passive network matrix element 301, a (reconfigurable) switch arrangement 302 and a power divider—power combiner element 303, all of which are connected in series in this order. The reconfigurable passive network block may have M+1 inputs/outputs (as shown also in FIG. 2) so that the passive network matrix has M inputs/outputs each of which is connected to an individual antenna element of the antenna array and the power divider—power combiner element 303 has a single input/output connected to the isolator.

The passive network matrix element 301 may be configured to combine a plurality of signals (M signals) received from one or more antenna elements (M antenna elements) to form one or more signals received by one or more reception beams (M reception beams) and to combine one or more signals received from the switch arrangement to form one or more signals to be fed to the one or more antenna elements (M antenna elements) producing one or more transmission beams. Obviously, since the passive network block 202 is, as the name states, passive, the beams available for transmission and reception are the same though different beams may be activated during transmission and reception depending on the selected configuration of the switch arrangement 302. In particular, each reception/transmission beam may correspond to a particular beam pointing angle in elevation. The passive network matrix element 301 may be configured to provide a set of beams substantially covering a 180° sector (or a −90°-+90° sector) in elevation or any other pre-defined elevational sector.

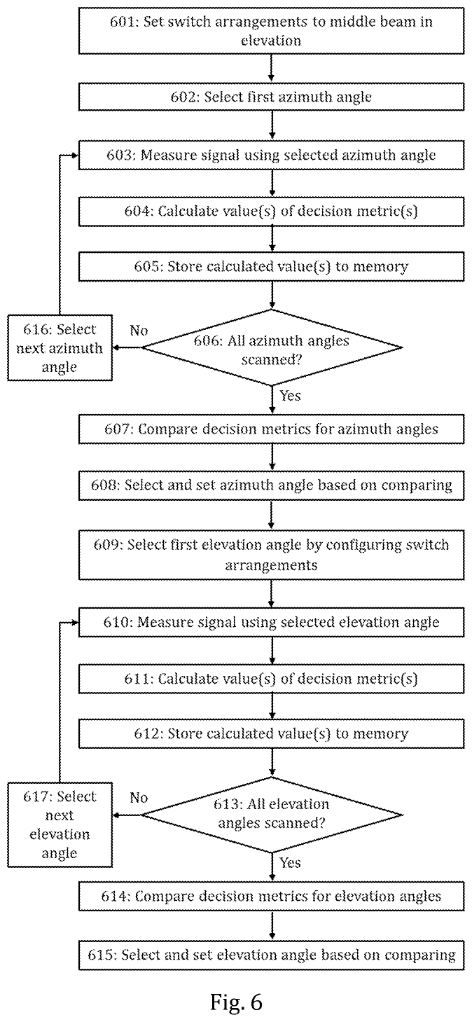

In general, the passive network matrix element may be any linear electronic network which is passive and realizes the aforementioned functionalities. The one or more antenna elements correspond specifically to M=8 antenna elements in the exemplary embodiments illustrated in FIGS. 2 and 3. The passive network matrix element 301 according to an exemplary embodiment is discussed in more detail in relation to FIG. 5.

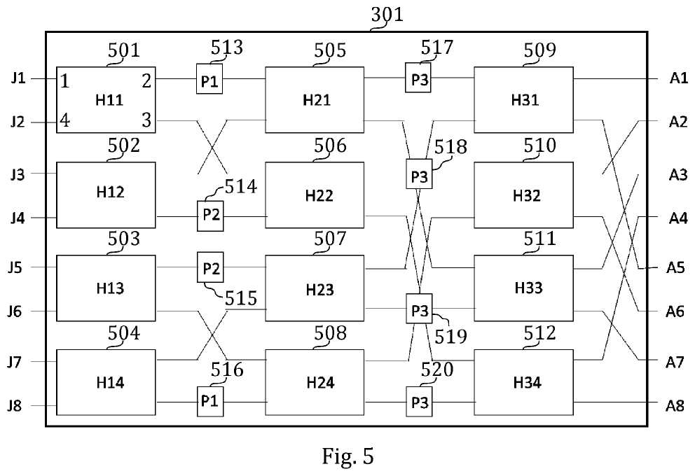

The switch arrangement 302 may be configured to select one or more beams for transmission and reception using a plurality of switches controlling which signals are fed to the passive network element in transmission and received from the passive network element in reception. The switch arrangement may operate reciprocally. The switching of the switch arrangement 302 may be controlled (fully or in part) using a control signal 304 received via control line from the baseband processing apparatus. In beam scanning operation, the switch arrangement 302 may be configured by the baseband processing apparatus to activate all the beams, one beam at a time, in sequence. Considering a rectangular N×M antenna array as described above, this type of switching corresponds to an elevation scan. The switch arrangement 302 according to an exemplary embodiment is discussed in more detail in relation to FIG. 4.

The power divider—power combiner element 303 may be configured to combine one or more signals (M signals in the illustrated embodiment) received from the switch arrangement in reception and to divide a signal received from a corresponding RF front end in transmission (to M signals in the illustrated embodiment).

In addition to the aforementioned control signal 304 fed to the switch arrangement 302, the passive network block 202 may be configured to receive a separate enable signal 305 from the baseband processing apparatus. The enable signal 305 is used for enabling (activating) or disabling (deactivating) the passive network block 202. When a passive network block is disabled, no signal is fed or received from the antenna elements connected to that particular passive network block.

FIG. 4 illustrates an exemplary embodiment for implementing a switch arrangement 202 as discussed in relation to FIG. 3. Each of the plurality of switch arrangements in the plurality of reconfigurable passive network blocks may have the same structure as illustrated in FIG. 4. The illustrated switch arrangement 202 may be used with the embodiments illustrated in FIGS. 2 and 3.

Referring to FIG. 4, the illustrated switch arrangement 202 is a M×M matrix switch, where M is equal to 8. In other words, the switch arrangement is symmetrical structure comprising at one side M input/output ports 401 each of which provides a connection to each of M input/output ports 402 on the other side of the switch arrangement 401 when all of the plurality of switches 403 of the switch arrangement are in a closed state. FIG. 4 illustrates the opposite configuration, that is, the configuration where all of the plurality of switches 403 are open and the switch arrangement 202 corresponds to an open circuit. By toggling the individual switches 403, different switch configurations (i.e., different connections between ports at different sides of the switch arrangement) may be achieved. Each of the individual switches 403 (or at least some of them) may be controlled by a control signal transmitted by the baseband processing apparatus.

FIG. 5 illustrates an exemplary embodiment for implementing a passive network matrix element 301 as discussed in relation to FIG. 3. Each of the plurality of passive network matrix elements in the plurality of reconfigurable passive network blocks may have the same structure as illustrated in FIG. 5. The illustrated passive network element 301 specifically corresponds to the case where each passive network element is connected to 8 antenna elements (as illustrated also in FIG. 2). Thus, the illustrated switch arrangement 202 may be used with the embodiments illustrated in FIGS. 2 and 3 (with M=8).

Referring to FIG. 5, the illustrated passive network matrix element 301 comprises 12 90° hybrid couplers 501, 502, 503, 504, 505, 506, 507, 508, 509, 510, 511, 512 and 8 phase shifters 513, 514, 515, 516, 517, 518, 519, 520 connected between said 90° hybrid couplers. The passive network matrix element further comprises 8 input/output ports J1, J2, J3, J4, J5, J6, J7, J8 on one side of the passive network matrix element and 8 input/output ports A1, A2, A3, A4, A5, A6, A7, A8 on the other side of the passive network matrix element.

The 90° hybrid couplers, which are arranged in FIG. 5 in three distinct combining stages each comprising 4 90° hybrid couplers in parallel, are used for combining the M signals (M=8 in FIG. 5) received from the M antenna elements (in reception) and for combining the one or more signals received from the switch arrangement (in transmission). If M is not equal to eight, the number of combining stages is also different. For example, M is equal to 4 or 16, 2 or 4 combining stages, respectively, are required, each comprising 2 or 8 hybrid couplers in parallel using this architecture of the passive network matrix element. In general for M signals with M=2″, K being an integer, log 2(M) combining stages are required, each comprising M/2 hybrid couplers in parallel.

The 90° hybrid coupler (or simply the 90° hybrid) is a four-port passive and symmetric device. It has the property that, following port numbering as illustrated with element 501 of FIG. 5, the power applied to port 1 is coupled to port 2 and port 3, but is unable to couple to port 4. Further, the strength of coupling is 3 dB (a property specific to hybrid couplers) and the output signal of port 2 and the output signal of the port 3 have a phase difference of 90° (a property specific to 90° hybrid couplers). As the 90° hybrid coupler is a symmetric element, the power applied to port 2 is coupled to port 1 and port 4, but is unable to couple to port 3. The 90° hybrid coupler may be considered as a special case of a coupled line directional coupler.

The phase shifters 513, 514, 515, 516, 517, 518, 519, 520 connected between some of the 90° hybrid couplers of subsequent combining stages are used for adjusting phase shifting between signals before the combining. Some of the phase shifters 513, 514, 515, 516, 517, 518, 519, 520 may induce the same phase shift (specifically, elements 513 and 516, 514 and 515 and 517 to 520). The phase shifting enables in reception the forming of the M signals for reception corresponding to the M reception beams and the forming of M signals for transmission corresponding to the one or more transmission beams selected for transmission by the switch arrangement (i.e., based on the states of the plurality of switches). As discussed in relation to FIG. 3, only some (e.g., only one) of the M signals created by the passive network matrix element in reception may be able to pass on to the power divider—combiner element and further to the corresponding RF front end depending on the current configuration of the switch arrangement. Moreover, each beam may correspond to a different beam pointing angle in elevation, but the same beam pointing angle in azimuth (i.e., each set of M antenna elements forming a phased array may be arranged along a vertical direction).

It should be appreciated that in other embodiments, a variety of different circuit topologies may be employed for implementing the passive network matrix element. Similar operations (namely directional combining) as performed by the 90° hybrid couplers in the embodiment of FIG. 5 may be performed using many other types of directional couplers such as coupled line directional couplers, hybrid ring couplers, branch-line couplers and Wilkinson power dividers. A plurality of directional couplers of the chosen type may be combined with a plurality of phase shifters in multiple different topologies so as to realize the functionalities described above for the passive network matrix element.

In some embodiments, the passive network matrix element may comprise a plurality of directional couplers configured to combine the M signals received from the M antenna elements to produce M signals for reception and to combine the one or more signals received from the switch arrangement to produce M signals for transmission, wherein the combining is performed in one or more combining stages. Further, the passive network matrix element may comprise a plurality of phase shifters connected between at least some of the plurality of directional couplers (belonging to different combing phases) and configured to adjust phase shifting between signals before combining so that the M signals for reception correspond to the M reception beams (i.e., each signal for reception corresponding to one of the reception beams realizable by varying the configuration of the switch arrangement) and the M signals for transmission correspond to the one or more transmission beams selected for transmission by the switch arrangement.

As described above, the baseband processing apparatus may be configured to control the beam scanning by manipulating the switch arrangements of the plurality of the passive network blocks (beamforming in elevation) and by applying phase shifts using the combiner and divider circuits (beamforming in azimuth). In the following, detailed embodiments for performing the beam scanning and beam detection by the baseband processing apparatus is discussed in relation to FIGS. 6 and 7. In said embodiments, the baseband processing apparatus may be a baseband processing apparatus according to any of the aforementioned embodiments. However, it is assumed that the antenna array is a rectangular antenna array with N×M antenna elements, the plurality of reconfigurable passive network blocks comprises N reconfigurable passive network blocks and each reconfigurable passive network block is connected to M antenna elements forming a linear phased array providing beam scanning in an elevation direction by modifying the configuration of the reconfigurable passive network block, N and M being integers larger than or equal to two (enabling both azimuth and elevation scanning). It is further assumed that the baseband processing apparatus is configured to control beam scanning in an azimuth direction by controlling phase shifting applied by the divider circuit to signals fed to the plurality of analog front ends in transmission and by the combiner circuit to signals received from the plurality of analog front ends in reception.

In FIG. 6, the baseband processing apparatus controls, in block 601, the switch arrangement in each reconfigurable passive network block so that the same elevationally centralized beam (or at least substantially elevationally centralized beam) is active in each switch arrangement. In some alternative embodiments, a different, non-centralized elevational beam pointing direction may be selected though in most cases the elevationally centralized beam serves as the best starting point. Then, the baseband processing apparatus scans a reception beam in the azimuth direction by controlling the phase shifting applied by the combiner circuit and measuring a received signal at each azimuth angle. This is achieved by, first, selecting, by the baseband processing apparatus in block 602, a first azimuth angle for scanning (that is, largest or smallest angle for which a beam is defined, e.g., 5°). Second, the baseband processing apparatus measures, in block 603, a received signal using a beam corresponding to the selected first azimuth angle. In other words, the combiner circuit is configured to apply phase shifting to the plurality of signals received from the plurality of analog front ends so that a signal corresponding to reception with a beam pointing at the first azimuth angle is generated and fed to the baseband processing apparatus.

In response to the measuring of the received signal at the first azimuth angle, the baseband processing apparatus calculates, in block 604, values of one or more decision metrics based on the received signal and stores, in block 605, calculated values of the one or more decision metrics for said first azimuth angle to a memory. The one or more decision metrics may, for example, quantify signal strength and/or relative signal strength for the coded or decoded signal or for the individual symbols acquired after decoding the received signal. How the one or more decision metrics may be defined and calculated is discussed in detail in relation to FIG. 7. The memory may be a temporary memory or a buffer, that is, the baseband processing apparatus may buffer the one or more decision metrics. In some embodiments, the baseband processing apparatus may also store, in block 605, other information on the received signal to the memory such as the received digital baseband signal itself, a decoded or demodulated received digital baseband signal and/or further metrics.

After the storing in block 605, the baseband processing apparatus determines, in block 606, whether beams corresponding to all azimuth angles defined for azimuth beam scanning have been measured. If this is not the case, the baseband apparatus selects, in block 616, the next azimuth angle (e.g., 10° in this case) and repeats blocks 603 to 605 for the selected azimuth angle. This process is repeated until it is determined in block 606 that all the azimuth angles have been covered.

After the azimuth scan is completed, the baseband processing apparatus compares, in block 607, the values of the one or more decision metrics for different azimuth angles. The baseband processing apparatus selects and sets, in block 608, an azimuth angle to be an azimuth beam direction for transmission and reception based on the comparing. Specifically, the selection is based on the selected azimuth angle having a maximum value of one of the one or more decision metrics or a maximum value of a pre-defined combination of one or more of the one or more decision metrics. In some embodiments, the selected azimuth angle may be required to further satisfy one or more pre-defined conditions (e.g., a decision metric having a value larger than a pre-defined threshold). The setting of the azimuth value comprises configuring by the baseband processing apparatus the combiner circuit and the divider circuit to apply phase shifting implementing a beam pointing at the selected azimuth angle in reception and transmission, respectively.

After the optimal azimuth angle has been determined and set, the baseband processing apparatus scans the reception beam (now corresponding to the selected azimuth pointing angle) in the elevation direction by changing the configurations of the plurality of switch arrangements and measuring a received signal at each elevation angle. Apart from the difference in how the beam scanning itself is achieved, this process is very similar to the one described for the azimuth angle. Namely, the baseband processing apparatus, first, selects, in block 609, a first elevation angle for scanning (that is, largest or smallest angle for which a beam is defined, e.g., −85° and then measures, in block 610, a received signal using a beam corresponding to the selected first elevation angle. In other words, the switch arrangement is configured to select a beam pointing at the first elevation angle.

The processing of the received signal in elevational scanning is also similar to the processing of the received signal in azimuthal scanning. In response to the measuring of the received signal at the first elevation angle, the baseband processing apparatus calculates, in block 611, values of the one or more decision metrics based on the received signal and stores, in block 612, calculated values of the one or more decision metrics for said elevation angle (and possibly other information as described in relation block 605) to the memory. After the storing in block 612, the baseband processing apparatus determines, in block 613, whether beams corresponding to all elevation angles defined for elevation beam scanning (i.e., realizable using the plurality of passive network blocks and switch arrangements) have been measured. If this is not the case, the baseband apparatus selects, in block 617, the next elevation angle (e.g., −80° in this case) and repeats blocks 610 to 612 for the selected azimuth angle. This process is repeated until it is determined in block 613 that all the azimuth angles have been covered.

After the elevation scan is completed, the baseband processing apparatus compares, in block 614, the values of the one or more decision metrics for different elevation angles. The baseband processing apparatus selects and sets, in block 615, an elevation angle to be an elevation beam direction for transmission and reception based on the comparing. Specifically, the selection is based on the selected elevation angle having a maximum value of one of the one or more decision metrics or a maximum value of a pre-defined combination of one or more of the one or more decision metrics. The setting of the elevation angle comprises configuring by the baseband processing apparatus the switch arrangements of the plurality of the passive network blocks so as to select a beam pointing at the selected elevation angle in reception and transmission.

After both the azimuth and the elevation angle have been selected and the beamforming antenna system has been configured accordingly (i.e., to employ said azimuth and elevation angles), the baseband processing apparatus may receive and process (e.g., decode) signals using a reception beam pointing at the selected azimuth and elevation angles and/or generate digital baseband signals and transmit said digital baseband signals (in the form of RF signals) using a transmission beam pointing at the selected azimuth and elevation angles. The reception and transmission beams correspond to the same radiation pattern (i.e., directivity pattern).

While above it was assumed that the same one or more decision metrics were calculated during the azimuth and elevation scanning, in some embodiments different or at least partially different decision metrics may be used in these two scans.

FIG. 7 illustrates a more detailed embodiment of some of the actions described in relation to FIG. 6. Specifically, FIG. 7 illustrates a more detailed embodiment relating to blocks 603 to 606 and 616 (i.e., azimuth measurements) and/or blocks 610 to 613 and 617 (i.e., elevation measurements).

Referring to FIG. 7, after the first azimuth or elevation angle has been selected and the beamforming antenna system has been configured accordingly (according to block 602 or 609, respectively), the baseband processing apparatus receives, in block 701, a signal (i.e., a digital baseband signal) corresponding to reception with a reception beam having a pointing angle corresponding to the first azimuth or elevation angle. Before the one or more decisions metrics may be calculated, the received signal may be processed in the following manner. First, the baseband processing apparatus decodes or demodulates, in block 702, the received signal based on information on known features of the received signal. The known features of the received signal may comprise information on one or more of bandwidth, operating frequency, modulation type, modulation order, pulse shaping format and frame format. The decoded signal (i.e., a received data signal) is in most cases inherently noisy due to its transmission through a noisy channel. To improve the signal-to-noise-ratio of the decoded signal, the baseband processing apparatus performs, in block 703, matched filtering on the decoded signal based on a known signal pattern. The known signal pattern may corresponds to one of a preamble, midamble, a regularly transmitted pilot pattern and a spreading sequence. In matched filtering, the so-called matched filter is obtained by correlating the known signal pattern with an unknown signal (i.e., the decoded signal) to detect the presence of the known signal pattern in the unknown signal. Moreover, the baseband apparatus may also perform, in block 703, synchronization based on said known signal pattern.

After the signal has been received and processed in blocks 701 to 703, the baseband processing apparatus calculates the one or more decision metrics as described in relation to FIG. 6. Specifically in the embodiment illustrated in FIG. 7, the baseband processing apparatus calculates, in block 704, a sensing metric M defined as

$$M = Re [ {\sum }_{n = 1}^{N} y ( n ) {s}^{*} ( n ) ] ,$$

wherein n is a sample index, N is the length of the known signal pattern, y(n) is the received signal assumed to have the form y(n)=s(n)+w(n), s(n) is a signal to be detected having the known signal pattern, w(n) is an Additive White Gaussian Noise, AWGN, sample, * is a complex conjugate. In the presence of a transmitted signal (i.e., y(n)=s(n)+w(n) with s(n)≠0), the sensing metric M may be written as

$$M = {\sum }_{n = 1}^{N} {\vert s ( n ) \vert}^{2} + Re [ {\sum }_{n = 1}^{N} w ( n ) {s}^{*} ( n ) ]$$

while in the absence of the transmitted signal (i.e., y(n)=w(n)), the sensing metric M may be written as

$$M = Re [ {\sum }_{n = 1}^{N} w ( n ) {s}^{*} ( n ) ] .$$

The baseband processing apparatus further calculates, in block 705, two sensing metrics describing the properties of the received data signal per symbol. Specifically, the baseband processing apparatus calculates, in block 705, a first symbol-specific sensing metric M₁ quantifying symbol energy relative to noise energy and a second symbol-specific sensing metric M₂ quantifying symbol energy relative to error energy. The symbol energy, noise energy and the error energy may be defined, respectively, as the total energy carried by a pre-determined number of symbols (e.g., N), the total energy contained in the noise corresponding to the pre-determined number of symbols and the total energy carried by symbols (of the pre-determined number of symbols) corresponding to symbol errors. The aforementioned energies may be defined alternatively as averages over said pre-determined number of symbols. In some embodiments, the one or more decision metrics calculated by the baseband processing apparatus may comprise one or more of the first symbol-specific sensing metric M₁, the second symbol-specific sensing metric M₂ and the sensing metric M.

After the calculation of the one or more decision metrics (i.e., M₁, M₂ and/or M), the baseband processing apparatus may perform the actions relating to blocks 706, 707, 708 in a similar manner as described in relation to blocks 605, 606, 616 or 612, 613, 617 of FIG. 6.

As described in relation to FIG. 6, the selecting of the azimuth and/or elevation angle to be an azimuth and/or elevation beam direction for transmission and reception may be based on the selected azimuth and/or elevation angle having a maximum value of one of the one or more decision metrics (e.g., a maximum value of M) or of a pre-defined combination of one or more of the one or more decision metrics (e.g., M₀=M₀(M, M₁, M₂)). As an example of the latter case, the pre-defined combination may be, for example, M₀=aM+bM₁+cM₂, where a, b and c are weighting factors.

In some embodiments, the selecting may be based on a decision metric having a maximum value while one or more pre-defined conditions are also satisfied. For example, the selecting may be based on a maximum value of M with the condition that the first and/or second symbol-specific sensing metrics have values exceeding pre-defined threshold(s), i.e., M₁>L_{E,1} and M₂>L_{E,2}, where λ_{E,1} and λ_{E,2} are pre-defined thresholds. For example, the baseband processing apparatus may first check for which azimuth/elevation angles the conditions are satisfied and only then select the azimuth/elevation angle from the azimuth/elevation angles satisfying said conditions.

In some embodiments, after the comparing of the values of the one or more decision metrics for different azimuth angles (block 307) or the comparing of the values of the one or more decision metrics for different elevation angles (block 315), the baseband processing apparatus may compare a maximum value of one of the one or more decision metrics or of a pre-defined combination of one or more of the one or more decision metrics to a pre-defined threshold (e.g., M₁>λ_{E}). If the maximum value is smaller than the pre-defined threshold, the baseband processing apparatus may repeat the beam scanning and detection (that is, process may proceed back to block 701) until a maximum value exceeding the pre-defined threshold is calculated or a pre-determined number of repetitions is reached. The baseband processing apparatus may wait for a pre-determined amount of time before initiating a repetition of the beam scanning and detection process.

The decision of the occupancy of a frequency band can be obtained by comparing the decision metric M against a fixed threshold λ_{E}. In some embodiments, the baseband processing apparatus may be configured to evaluate the performance of the detection method by calculating (e.g., continuously or periodically) the probability of detection P_{D} and the probability of false alarms P_{F}. The probability of detection P_{D} and the probability of false alarms P_{F} may be defined as

P_{D}=Pᵣ(M>λ_{E}|H₁),

where H₁: y(n)=s(n)+w(n), and

P_{F}=Pᵣ(M>λ_{E}|H₀),

where H₀: y(n)=w(n). Obviously, a high probability of detection and a low probability of false alarms is desired. Based on the calculated probabilities showing undesirable values, the baseband processing apparatus may be configured to perform one or more actions to improve the detection, e.g., adjusting the gain of one or more of the plurality of RF front ends and/or the plurality of RF front ends.

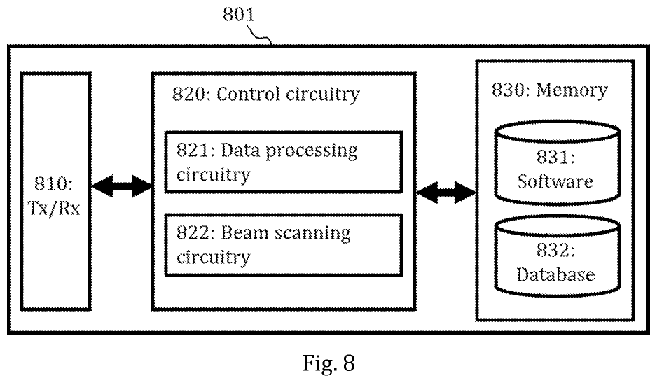

FIG. 8 illustrates an exemplary apparatus 801 configured to carry out at least the functions described above in connection with the baseband processing apparatus in a beamforming antenna system as illustrated in any one of FIGS. 2 to 5. Further, the illustrated apparatus may be configured to carry out any of the actions described in relation to FIGS. 6 and 7. The apparatus may be an electronic device comprising electronic circuitries. The apparatus may be a separate entity or a plurality of separate entities. The apparatus may comprise a control circuitry 820 such as at least one processor, and at least one memory 830 including a computer program code (software) 831 wherein the at least one memory and the computer program code (software) are configured, with the at least one processor, to cause the apparatus to carry out any one of the embodiments of the baseband processing apparatus described above.

The memory 830 may be implemented using any suitable data storage technology, such as semiconductor based memory devices, flash memory, magnetic memory devices and systems, optical memory devices and systems, fixed memory and removable memory. The memory may comprise a database 832 which may be or comprise the database as described in relation to previous embodiments. The memory 830 may be connected to the control circuitry 820 via an interface.

The apparatus may further comprise interfaces 810 comprising hardware and/or software for realizing connectivity according to one or more communication protocols. The interfaces 810 may comprise, for example, interfaces enabling the connections between the apparatus 801 and other apparatuses as described, e.g., in relation to FIGS. 2 to 5. In some embodiments, the interfaces 810 may provide the apparatus with communication capabilities to communicate in the cellular communication system and enable communication with network nodes and terminal devices, for example. The interfaces 810 may comprise standard well-known components such as an amplifier, filter, frequency-converter, (de)modulator, and encoder/decoder circuitries and one or more antennas.

Referring to FIG. 8, the control circuitry 820 may comprise data processing circuitry 821 configured to perform the processing of the received digital signals and the generation of the digital signals for transmission. Moreover, the control circuitry 820 comprises beam scanning circuitry 822 configured to perform the beam scanning, beamforming and beam detection operations. Specifically, the beam scanning circuitry may be configured to perform any of the actions described in relation any of the embodiments illustrated in FIGS. 2 to 7 (apart from the action attributed to the data processing circuitry above).

As used in this application, the term “circuitry” may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with software/firmware and

(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device

In an embodiment, at least some of the processes described in connection with FIGS. 6 and 7 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 6 and 7 or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chipset (procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 6 and 7 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A beamforming antenna system, comprising:
an antenna array comprising a plurality of antenna elements configured to transmit and receive radio signals;
a plurality of reconfigurable passive network blocks configured to form beams for transmission and reception by modifying radio signals to be fed to and received from the plurality of antenna elements according to a configuration of each reconfigurable passive network block, wherein each reconfigurable passive network block is connected to two or more antenna elements and the configuration is defined based on a state of a switch arrangement comprised in each reconfigurable passive network block;
a plurality of radio frequency (RF) front ends connected to a plurality of analog front ends configured to convert radio frequency signals received via the plurality of reconfigurable passive network blocks to digital baseband signals in receive paths of the plurality of RF and analog front ends and to convert digital baseband signals to radio frequency signals for transmission via the plurality of reconfigurable passive network blocks in transmit paths of the plurality of RF and analog front ends; and
a baseband processing apparatus configured to generate a digital baseband signal to be fed via a divider circuit to the plurality of analog front ends for transmission, to process a baseband signal received via a combiner circuit from the plurality of analog front ends and to control the configuration of the plurality of reconfigurable passive network blocks.

2. The beamforming antenna system of claim 1, wherein the antenna array is a rectangular antenna array with N×M antenna elements, the plurality of reconfigurable passive network blocks comprises N reconfigurable passive network blocks and each reconfigurable passive network block is connected to M antenna elements forming a linear phased array providing beam scanning in an elevation direction by modifying the configuration of the reconfigurable passive network block, N and M being integers larger than or equal to two.

3. The beamforming antenna system of claim 2, wherein the baseband processing apparatus is configured to control beam scanning in an azimuth direction by controlling phase shifting applied by the divider circuit to signals fed to the plurality of analog front ends in transmission and by the combiner circuit to signals received from the plurality of analog front ends in reception.

4. The beamforming antenna system of claim 3, wherein each of the plurality of reconfigurable passive network blocks comprises a passive network matrix element, the switch arrangement and a power divider—power combiner element connected in series, wherein
the passive network matrix element is configured to combine M signals received from the M antenna elements to form M signals received by M reception beams and to combine one or more signals received from the switch arrangement to form M signals to be fed to the M antenna elements producing one or more transmission beams,
the switch arrangement is configured to select beams for transmission and reception based on a plurality of switches controlling which signals are fed to the passive network element in transmission and passed on to the power combiner of the power divider—power combiner element in reception; and
the power divider—power combiner element is configured to combine one or more signals received from the switch arrangement in reception and to divide a signal received from a corresponding RF front end in transmission.

5. The beamforming antenna system of claim 3, wherein the baseband processing apparatus is configured to control switching of the plurality of switches of the switch arrangement, activation and deactivation of each reconfigurable passive network block and gain and clock of one or more RF front ends and one or more analog front ends.

6. The beamforming antenna system according to claim 3, further comprising:
a plurality of isolators connected between the plurality of passive network blocks and the plurality of RF front ends and configured to isolate received signals from signals to be transmitted.

7. The beamforming antenna system according to claim 4, wherein each passive network matrix element comprises:
a plurality of directional couplers configured to combine the M signals received from the M antenna elements to produce M signals for reception and to combine the one or more signals received from the switch arrangement to produce M signals for transmission, wherein the combining is performed in one or more combining stages; and
a plurality of phase shifters connected between at least some of the plurality of directional couplers and configured to adjust phase shifting between signals before combining so that the M signals for reception correspond to the M reception beams and the M signals for transmission correspond to the one or more transmission beams selected for transmission by the switch arrangement.

8. The beamforming antenna system of claim 7, wherein the plurality of directional couplers comprise 90° hybrid couplers.

9. The beamforming antenna system according to claim 3, wherein the switch arrangement comprises an M×M matrix switch.

10. The beamforming antenna system of claim 3, wherein each of the plurality of RF front ends comprises in a transmit path of the RF front end one or more of power amplifiers, upconverters and RF filters and in a receive path of the RF front end one or more of RF filters, downconverters and low noise amplifiers or each of the plurality of analog front ends comprises in a transmit path of the analog front end one or more of digital-to-analog converters and filters and in a receive path of the analog front end one or more of filters, gain amplifiers and analog-to-digital converters.

11. The beamforming antenna system according to claim 3, wherein N is equal to M.

12. The beamforming antenna system of claim 3, wherein one or more of the plurality of RF front ends, the plurality of analog front ends, the combiner circuit, the divider circuit and the baseband processing apparatus are implemented on a single chip.

13. The beamforming antenna system according to claim 3, wherein the baseband processing apparatus is further configured to perform beam scanning and detection by:
controlling the switch arrangement in each reconfigurable passive network block so that the same elevationally centralized beam is active;
scanning a reception beam in the azimuth direction by controlling the phase shifting applied by the combiner circuit and measuring a received signal at each azimuth angle;
in response to each measuring of a received signal at an azimuth angle, calculating values of one or more decision metrics quantifying signal strength based on the received signal and storing calculated values of the one or more decision metrics for said azimuth angle to a memory;
comparing the values of the one or more decision metrics for different azimuth angles;
selecting an azimuth angle to be an azimuth beam direction for transmission and reception based on the selected azimuth angle having a maximum value of one of the one or more decision metrics or of a pre-defined combination of one or more of the one or more decision metrics;
scanning the reception beam in the elevation direction by changing the configurations of the plurality of switch arrangements and measuring a received signal at each elevation angle;
in response to each measuring of a received signal at an elevation angle, calculating values of the one or more decision metrics based on the received signal and storing calculated values of the one or more decision metrics for said elevation angle to a memory;
comparing the values of the one or more decision metrics for different elevation angles; and
selecting an elevation angle to be an elevation beam direction for transmission and reception based on the selected elevation angle having a maximum value of one of the one or more decision metrics or of a pre-defined combination of one or more of the one or more decision metrics.

14. The beamforming antenna system of claim 13, wherein the measuring of the received signal at the azimuth angle or the elevation angle comprises:
receiving a signal;
decoding the received signal based on information on known features of the received signal;
performing matched filtering and synchronization on the decoded signal by correlating a known signal pattern with the filtered signal, wherein the known signal pattern corresponds to one of a preamble, midamble, a regularly transmitted pilot pattern and a spreading sequence.

15. The beamforming antenna system of claim 14, wherein the information on known features of the received signal comprises information on one or more of bandwidth, operating frequency, modulation type, modulation order, pulse shaping format and frame format.

16. The beamforming antenna system according to claim 13, wherein the one or more decision metrics comprise one or more of a first symbol-specific sensing metric M₁ quantifying symbol energy relative to noise energy, a second symbol-specific sensing metric M₂ quantifying symbol energy relative to error energy and a sensing metric M defined as
$$M = Re [ {\sum }_{n = 1}^{N} y ( n ) {s}^{*} ( n ) ] ,$$
wherein n is a sample index, N is the length of a known signal pattern, y(n) is the received signal assumed to have the form y(n)=s(n)+w(n), s(n) is a signal to be detected having the known signal pattern, w(n) is an Additive White Gaussian Noise, AWGN, sample and * is a complex conjugate.

17. The beamforming antenna system according to claim 13, wherein the performing of the beam scanning and detection further comprises:
after the comparing of the values of the one or more decision metrics for different azimuth angles or the comparing of the values of the one or more decision metrics for different elevation angles, comparing a maximum value of one of the one or more decision metrics or of a pre-defined combination of one or more of the one or more decision metrics to a pre-defined threshold; and
if the maximum value is smaller than the pre-defined threshold, repeating the beam scanning and detection until a maximum value exceeding the pre-defined threshold is calculated or a pre-determined number of repetitions is reached.

18. The beamforming antenna system according to claim 1, wherein the baseband processing apparatus comprises:
at least one processor; and
at least one memory including computer program code, the at least one memory and computer program code configured to, with the at least one processor, control performance of the baseband processing apparatus.

19. A method comprising:
providing a beamforming antenna system according to claim 3;
controlling, by the baseband processing apparatus of the beamforming antenna system, the switch arrangement in each reconfigurable passive network block so that the same elevationally centralized beam is active;
scanning, by the baseband processing apparatus, a reception beam in the azimuth direction by controlling the phase shifting applied by the combiner circuit and measuring a received signal at each azimuth angle;
in response to each measuring of a received signal at an azimuth angle, calculating, by the baseband processing apparatus, values of one or more decision metrics quantifying signal strength based on the received signal and storing calculated values of the one or more decision metrics for said azimuth angle to a memory;
comparing, by the baseband processing apparatus, the values of the one or more decision metrics for different azimuth angles;
selecting, by the baseband processing apparatus, an azimuth angle to be an azimuth beam direction for transmission and reception based on the selected azimuth angle having a maximum value of one of the one or more decision metrics or of a pre-defined combination of one or more of the one or more decision metrics;
scanning, by the baseband processing apparatus, the reception beam in the elevation direction by changing the configurations of the plurality of switch arrangements and measuring a received signal at each elevation angle;
in response to each measuring of a received signal at an elevation angle, calculating, by the baseband processing apparatus, values of the one or more decision metrics based on the received signal and storing calculated values of the one or more decision metrics for said elevation angle to the memory;
comparing, by the baseband processing apparatus, the values of the one or more decision metrics for different elevation angles; and
selecting, by the baseband processing apparatus, an elevation angle to be an elevation beam direction for transmission and reception based on the selected elevation angle having a maximum value of one of the one or more decision metrics or of a pre-defined combination of one or more of the one or more decision metrics.

20. A computer program embodied on a non-transitory computer-readable medium, said program comprising instructions which, when run on a computer, cause an apparatus to perform at least the following:
controlling a switch arrangement in each reconfigurable passive network block of a plurality of reconfigurable passive network blocks so that the same elevationally centralized beam is active, wherein the plurality of reconfigurable passive network blocks are configured to form beams for transmission and reception by modifying radio signals to be fed to and received from an antenna array comprising a plurality of antenna elements according to a configuration of each reconfigurable passive network block, wherein each reconfigurable passive network block is connected to two or more antenna elements forming a linear phased array providing beam scanning in an elevation direction and the configuration is defined based on a state of a switch arrangement comprised in each reconfigurable passive network block;
scanning a reception beam in the azimuth direction by controlling the phase shifting applied by a combiner circuit and measuring a received signal at each azimuth angle, wherein the combiner circuit is configured to receive and combine baseband signals from a plurality of analog front ends connected to the plurality of reconfigurable passive network blocks via a plurality of RF front ends;
in response to each measuring of a received signal at an azimuth angle, calculating values of one or more decision metrics quantifying signal strength based on the received signal and storing calculated values of the one or more decision metrics for said azimuth angle to a memory;
comparing the values of the one or more decision metrics for different azimuth angles;
selecting an azimuth angle to be an azimuth beam direction for transmission and reception based on the selected azimuth angle having a maximum value of one of the one or more decision metrics or of a pre-defined combination of one or more of the one or more decision metrics;
scanning the reception beam in the elevation direction by changing the configurations of the plurality of switch arrangements and measuring a received signal at each elevation angle;
in response to each measuring of a received signal at an elevation angle, calculating values of the one or more decision metrics based on the received signal and storing calculated values of the one or more decision metrics for said elevation angle to the memory;
comparing the values of the one or more decision metrics for different elevation angles; and
selecting an elevation angle to be an elevation beam direction for transmission and reception based on the selected elevation angle having a maximum value of one of the one or more decision metrics or of a pre-defined combination of one or more of the one or more decision metrics.
